(19) United States
(12) Patent Application Publication
(10) Pub. No.: US 2021/0141769 A1
(43) Pub. Date: May 13, 2021

(54) Moving File Sequences Together Across Multiple Folders

(71) Applicant: EMC IP Holding Company LLC, Hopkinton, MA (US)

(72) Inventor: Bhavesh Sharma, Hadapsar (IN)

(21) Appl. No.: 16/681,071

(22) Filed: Nov. 12, 2019

(51) Int. Cl. G06F 16/185; G06F 16/16; G06F 3/0482

(52) U.S. Cl. CPC G06F 16/185; G06F 3/0482; G06F 16/168

(57) ABSTRACT

Techniques are provided for moving file sequences together across multiple folders. In an example, a user provides input to transfer multiple files within a folder that are named according to a file sequence (e.g., LA_IMG100.JPG, LA_IMG101.JPG, and LA_IMG102.JPG). In response to receiving this user input, subfolders of this folder can be examined for additional files that are named according to the file sequence. Where these additional files are identifies in subfolders, they can also be transferred along with the original set of files.

### TECHNICAL FIELD

The present application relates generally to transferring computer data.

### BACKGROUND

Computer files can be transferred between a source and a destination. In some examples, multiple computer files can be selected via user input to be transferred together.

### BRIEF DESCRIPTION OF THE DRAWINGS

Numerous aspects, embodiments, objects, and advantages of the present invention will be apparent upon consideration of the following detailed description, taken in conjunction with the accompanying drawings, in which like reference characters refer to like parts throughout, and in which:

FIG. 1 illustrates a block diagram of an example computer system that can facilitate moving file sequences together across multiple folders;

FIG. 2 illustrates an example file directory structure that can be used in moving file sequences together across multiple folders;

FIG. 3 illustrates an example file directory structure that can be used in moving file sequences together across multiple folders;

FIG. 4 illustrates an example a second example file directory structure that can be used in moving file sequences together across multiple folders;

FIG. 5 illustrates an example user interface that can be used in moving file sequences together across multiple folders;

FIG. 6 illustrates an example process flow that can facilitate moving file sequences together across multiple folders;

FIG. 7 illustrates another example process flow that can facilitate moving file sequences together across multiple folders;

FIG. 8 illustrates another example process flow that can facilitate moving file sequences together across multiple folders;

FIG. 9 illustrates another example process flow that can facilitate moving file sequences together across multiple folders;

FIG. 10 illustrates an example block diagram of a computer operable to execute certain embodiments of this disclosure.

### DETAILED DESCRIPTION

### Overview

In the media industry, often a customer deals with file sequences. For example, photos taken for any given event on any given day can follow a defined naming format like, LA_IMG100.JPG, LA_IMG101.JPG, LA_IMG102.JPG, etc.

There are ways to display file sequence information like this in a user interface. One approach is to process the sequenced files and display the sequence like LA_IMG[100-102].JPG in an application user interface, so that a user can select the sequence as a whole and initiate data transfer. A problem with some approaches like this is that only the files of one folder are displayed. So, if a user first selects FOLDER_A, he or she is then presented with files present in FOLDER_A in sequence. So, if the file sequence carries into a subfolder, the user can need to manually navigate to the subfolder (e.g., SUBFOLDER_B) and repeat a transfer process, even though the files are all part of one file sequence.

Another approach to display file sequence information is to display each file in a separate row in a user interface. This approach can occupy a large portion of the user interface where there are many files in one file sequence that are each individually displayed, and can also require repeated user action to select each of these separately displayed files for transfer. Or, when the sequence of files is within one folder, then a user can have an option to select the file sequence at once for transfer. However, a user can lack an option to select an entire file sequence where the file sequence extends into subfolders.

Here, selecting a file sequence based on each file adhering to a particular naming convention can be distinguished from copying the contents of an entire folder without regard to a name of a file.

Consider an example where there is FOLDER A, within FOLDER A is a subfolder (FOLDER B), and within FOLDER B is another subfolder (FOLDER C). In this case, FOLDER A can be considered to be a parent folder of its subfolder, FOLDER B. In this example, FOLDER A contains a file sequence of LA_IMG100.JPG, LA_IMG101.JPG, and LA_IMG102.JPG. In this example, FOLDER B contains LA_IMG103.JPG and LA_IMG104.JPG, while FOLDER C contains LA_IMG105.JPG and LA_IMG106.JPG.

In some systems, if a user is presented with FOLDER A and selects the file sequence LA_IMG[100-102].JPG for file transfer, only LA_IMG100.JPG, LA_IMG101.JPG, and LA_IMG102.JPG will be transferred, even though there are other files in this file sequence located in subfolders. A problem exists because transferring the entire file sequence (LA_IMG[100-106].JPG) requires additional user involvement and takes additional time.

A solution is to simplify an approach to moving file sequences together across multiple folders. In an example approach, when a data transfer is invoked on any file sequence, then a file sequence in the current folder can be determined. Then, subfolders of the folder can be examined Where there are subfolders, each subfolder can be examined for the presence of more files in accordance with the file sequence. Continuing with the example above, the subfolder FOLDER B can be examined and it can be determined that it contains files LA_IMG103.JPG and LA_IMG104.JPG that adhere to the file sequence of parent folder FOLDER A. FOLDER C can be similarly examined.

All of these files across FOLDER A, FOLDER B, and FOLDER C that adhere to the file sequence can be selected for transfer. Information can be displayed in a user interface to a user that there are additional files in the file sequence available to be transferred (here, the files in FOLDER B and FOLDER C). The user can provide user input to the user interface to select some, all, or none of these additional files and continue with a transfer of those files that are selected.

This approach can be implemented via a service that executes on a source computer from which files are being transferred. This approach can reduce an amount of manual effort for a user to find files manually and manually transfer each set of files within a folder.

In one approach, a file name contains one period (“.”) and it is located before the extension, e.g., LA_IMG100.JPG (where the extension is “JPG”). In such approaches, a number immediately preceding the period can be searched for in a file name, and used as the basis for determining whether there is a file sequence. So, a service that implements this approach can look for file names that begin with “LA_IMG,” then analyze a number that is contained between “LA_IMG” and the period and extension (“.JPG”) for being part of a file sequence.

In other examples, different types of file sequences can be contained or identified within file names.

### Example Architecture

FIG. 1 illustrates a block diagram of an example computer system 100 that can facilitate moving file sequences together across multiple folders. Computer system 100 comprises source computer 102a, destination computer 102b, and communications network 108.

Source computer 102a comprises file system transfer component 104 and file system 106a. In some examples, aspects of computer 1002 of FIG. 10 can be used to implement aspects of source computer 102a. File system transfer component 104 can comprise computer software and/or hardware that implements aspects of process flow 600 of FIG. 6, process flow 700 of FIG. 7, process flow 800 of FIG. 8, and/or process flow 900 of FIG. 9. File system 106a can comprise a computer file system that stores computer data in a hierarchical, logical structure comprising folders (sometimes referred to as directories) and files stored within those folders.

Destination computer 102b comprises file system 106b. File system 106b can be similar to file system 106a. In some examples, aspects of computer 1002 of FIG. 10 can be used to implement aspects of destination computer 106b.

Communications network 108 comprises a computer network capable of transferring computer communications between two or more computers, such as the INTERNET or an intranet.

In FIG. 1, file sequence transfer component 104 is depicted as being part of source computer 102a. It can be appreciated that there can be embodiments where a file sequence transfer component is part of destination computer 102b. It can be appreciated that there also can be embodiments where a file sequence transfer component is part of a third computer that is separate from source computer 102a and destination computer 102b.

Additionally, in FIG. 1, a transfer that incorporates aspects of moving file sequences together across multiple folders can be made from one part of a file system of a computer to another part of a file system of that same computer. for example, in some examples, a transfer that incorporates aspects of moving file sequences together across multiple folders can be made from one portion of file system 106a to another portion of file system 106a. For example, the source can be file path /home/a/ (and associated subfolders of that folder) of file system 106a, and the destination can be file path /home/b/ (and associated subfolders of that folder) of file system 106b.

### Example File Directory Structures

FIG. 2 illustrates an example file directory structure 200 that can be used in moving file sequences together across multiple folders. File directory structure 200 comprises file system 202 and file sequence transfer component 204. In some examples, file system transfer component 204 can be similar to file system transfer component 104 of FIG. 1.

File system 202 can be similar to file system 102 of FIG. 1. As depicted, file system comprises FOLDER 206, LA_IMG100.JPG 208a, LA_IMG101.JPG 208b, LA_IMG102.JPG 208c, LA_IMG103.JPG 208d, LA_IMG104.JPG 208e, and LA_IMG105.JPG 208f. FOLDER 206 comprises a computer folder, which contains LA_IMG100.JPG 208a, LA_IMG101.JPG 208b, LA_IMG102.JPG 208c, LA_IMG103.JPG 208d, LA_IMG104.JPG 208e, and LA_IMG105.JPG 208f. Each of LA_IMG100.JPG 208a, LA_IMG101.JPG 208b, LA_IMG102.JPG 208c, LA_IMG103.JPG 208d, LA_IMG104.JPG 208e, and LA_IMG105.JPG 208f comprise a computer file.

As depicted, FOLDER 206 does not have any subfolders. Additionally, as depicted, LA_IMG100.JPG 208a, LA_IMG101.JPG 208b, LA_IMG102.JPG 208c, LA_IMG103.JPG 208d, LA_IMG104.JPG 208e, and LA_IMG105.JPG 208f make up a sequence of files because they contain a numerical sequence across their names. LA_IMG100.JPG 208a contains “100” in its file name; LA_IMG101.JPG 208b contains “101” in its file name; LA_IMG102.JPG 208c contains “102” in its file name; LA_IMG103.JPG 208d contains “103” in its file name; LA_IMG104.JPG 208e contains “104” in its file name; and LA_IMG105.JPG 208f contains “105” in its file name Thus, the files collectively contain a numerical sequence from 100 to 105, and in some examples, can be expressed collectively as LA_IMG[100-105].jpg.

In some examples, file sequence transfer component 204 can effectuate a transfer of this sequence of files comprising the files LA_IMG100.JPG 208a, LA_IMG101.JPG 208b, LA_IMG102.JPG 208c, LA_IMG103.JPG 208d, LA_IMG104.JPG 208e, and LA_IMG105.JPG 208f.

FIG. 3 illustrates another example file directory structure 300 that can be used in moving file sequences together across multiple folders. File directory structure 300 comprises file system 302 and file sequence transfer component 304. In some examples, file system transfer component 304 can be similar to file system transfer component 104 of FIG. 1.

File system 302 can be similar to file system 102 of FIG. 1. File system 302 comprises FOLDER_A 306a. In turn, FOLDER_A 306a comprises LA_IMG100.JPG 308a, LA_IMG101.JPG 308b, and FOLDER_B 306b. In turn, FOLDER_B 306b comprises LA_IMG102.JPG 308c, LA_IMG103.JPG 308d, and FOLDER_C 306c. In turn, FOLDER_C 306c comprises LA_IMG104.JPG 308e, and LA_IMG105.JPG 308f.

FOLDER_C 306c can be considered to be a subfolder of FOLDER_B 306b, and both FOLDER_C 306c and FOLDER_B 306b can be considered to be subfolders of FOLDER_A 306a. Then, file sequence transfer component 304 can identify a sequence of files comprising IMG100.JPG 308a, LA_IMG101.JPG 308b, LA_IMG102.JPG 308c, LA_IMG103.JPG 308d, LA_IMG104.JPG 308e, and LA_IMG105.JPG 308f. This file sequence can be expressed as LA_IMG[100-105].JPG. File sequence transfer component 304 can identify this file sequence and transfer it to a destination, even though the files of the file sequence span multiple subfolders.

FIG. 4 illustrates another file directory structure 400 that can be used in moving file sequences together across multiple folders. File directory structure 400 comprises file system 402 and file sequence transfer component 404. In some examples, file system transfer component 404 can be similar to file system transfer component 104 of FIG. 1.

File system 402 comprises FOLDER 406a. In turn, FOLDER 406a comprises LA_IMG100.JPG 408a, LA_IMG101.JPG 408b, DC_IMG101.JPG 408c, LA_IMG102.PNG 408d, and LA_IMG103.JPG 408e. In some examples, LA_IMG100.JPG 408a and LA_IMG101.JPG 408b form a file sequence (LA_IMG[100-101].JPG) while the other files (DC_IMG101.JPG 408c, LA_IMG102.PNG 408d, and LA_IMG103.JPG 408e) are not part of this file sequence. DC_IMG101.JPG 408c is not part of the file sequence because the non-numeric part of its file name (“DC_IMG”) is different from the non-numeric part of the file sequence (“LA_IMG”). LA_IMG102.PNG 408d is not part of the file sequence because it has a different extension (.PNG) than the extension of the file sequence (.JPG).

LA_IMG103.JPG 408e is not part of the file sequence because there is a gap in the numbers between the file sequence ([100-101]) and the numerical part of this file name (103). That is, a LA_IMG102.JPG is missing in this example. In other examples, such a gap is allowed in a file sequence, and LA_IMG103.JPG 408e is part of a file sequence along with LA_IMG100.JPG 408a and LA_IMG101.JPG 408b.

File sequence transfer component 404 can identify the file sequence contained within file system 402 among all of these files, and transfer it to a destination.

### Example User Interface

FIG. 5 illustrates an example user interface 500 that can be used in moving file sequences together across multiple folders. In some examples, user interface 500 can be generated by file sequence transfer component 104 of FIG. 1, file sequence transfer component 204 of FIG. 2, file sequence transfer component 304 of FIG. 3, and/or file sequence transfer component 404 of FIG. 4. In some examples, user input received at user interface 500 can be processed by file sequence transfer component 104 of FIG. 1, file sequence transfer component 204 of FIG. 2, file sequence transfer component 304 of FIG. 3, and/or file sequence transfer component 404 of FIG. 4.

User interface 500 comprises file list 502, and user interface elements 504. File list 502 can comprise a list of files, such as all or part of the files in file system 202 of FIG. 2, file system 302 of FIG. 3, and/or file system 402 of FIG. 4.

User interface elements 504 comprises Some check button 506a, All check button 506b, None check button 506c, and Transfer button 508. These aspects of user interface elements 504 can be used to indicate which files to transfer and to initiate the transfer.

For example, when a user selects multiple files to transfer (such as by clicking the respective file names in file list 502), the user can be presented with a dialogue that indicates that there are more files in that sequence that can be transferred, and those additional files are stored in a subfolder. If a user provides user input to check Some check button 506a, he or she can then be presented with an option to select the subset of the additional files that the user wishes to transfer. If the user provides user input to check All check button 506b, then all of the additional files can be identified for transfer. If the user provides user input to check None check button 506c, then none of these additional files can be identified for transfer (though, the user's originally-selected files can still be identified for transfer).

The user can then provide user input indicative of clicking on, or otherwise engaging with, Transfer button 508, and engaging Transfer button 508 can indicate to file sequence transfer component 104 of FIG. 1, file sequence transfer component 204 of FIG. 2, file sequence transfer component 304 of FIG. 3, and/or file sequence transfer component 404 of FIG. 4 to begin transferring the indicated files.

It can be appreciated that user interface 500 is an example user interface, and that there can be user interfaces in accordance with aspects of moving file sequences together across multiple folders that present different user interface elements than are depicted in user interface 500, and/or that depict the user interface elements of user interface 500 in a different arrangement than as depicted in user interface 500.

### Example Operating Procedures

FIG. 6 illustrates an example process flow 600 that can facilitate moving file sequences together across multiple folders, in accordance with certain embodiments of this disclosure. In some examples, aspects of process flow 600 can be implemented by file system transfer component 104 of FIG. 1, file system transfer component 204 of FIG. 2, file sequence transfer component 304 of FIG. 3, or file sequence transfer component 404 of FIG. 4. It can be appreciated that the operating procedures of process flow 600 are example operating procedures, and that there can be embodiments that implement more or fewer operating procedures than are depicted, or that implement the depicted operating procedures in a different order than as depicted.

Process flow 600 begins with 602, and moves to operation 604. Operation 604 depicts receiving user input of a file sequence, and initiating data transfer. This user input can be received at user interface 500, and initiating data transfer can comprise receiving user input indicative of engaging Transfer button 508. After operation 604, process flow 600 moves to operation 606.

Operation 606 depicts determining whether user input is received to check subfolders for file sequences. In some examples, a user interface can be presented to a user asking whether subfolders should be checked for file sequences, and containing a user interface button that indicates Yes and a user interface button that indicates No. Where the user provides user input indicative of engaging the Yes button, this can be determined in operation 606 that user input is received to check subfolders for file sequences.

If it is determined in operation 606 that user input is received to check subfolders for file sequences, then process flow 600 moves to operation 610. Instead, if it is determined in operation 606 that user input is not received to check subfolders for file sequences, then process flow 600 moves to operation 608.

Operation 608 is reached from operation 606 where it is determined in operation 606 that user input is not received to check subfolders for file sequences. Operation 608 depicts initiating data transfer on the selected files. Initiating data transfer on the selected files can be performed by file system transfer component 104 of FIG. 1, file system transfer component 204 of FIG. 2, file sequence transfer component 304 of FIG. 3, or file sequence transfer component 404 of FIG. 4, and performed in response to receiving user input at user interface 500 that subfolders should not be checked for more files in the file sequence. Initiating data transfer on the selected files can comprise copying those files to their indicated destination. After operation 608, process flow 600 moves to 616, where process flow 600 ends.

Operation 610 is reached from operation 606 where it is determined in operation 606 that user input is received to check subfolders for file sequences. Operation 610 depicts enumerating subfolders, and collecting information on files according to the file sequence. Enumerating subfolders can comprise identifying those subfolders of the folder in which the originally selected files (in operation 604) are contained. This process of enumerating subfolders can be performed recursively to find subfolders of subfolders, etc. In each subfolder, the files of that subfolder can be analyzed to determine whether their name conforms to the naming convention of the file sequence. After operation 610, process flow 600 moves to operation 612.

Operation 612 depicts displaying the file sequence found, and requesting user input on transferring them. The file sequence found can comprise those files found in the folder of operation 604, as well as those files in any subfolders whose name adheres to the naming convention of the file sequence.

Displaying the file sequence found can be performed by displaying the sequence in user interface 500 (such as in file list 502). Requesting user input on transferring them can be performed by providing a dialog requesting that the user provide user input to select one of Some check button 506a, All check button 506b, None check button 506c. After operation 612, process flow 600 moves to operation 614.

Operation 614 depicts transferring files according to the user input. This operation can comprise file system transfer component 104 of FIG. 1, file system transfer component 204 of FIG. 2, file sequence transfer component 304 of FIG. 3, or file sequence transfer component 404 of FIG. 4 transferring the files selected in operation 612 to the indicated destination. In some examples, operation 614 can be implemented in a similar manner as operation 608. After operation 614, process flow 600 moves to 616, where process flow 600 ends.

FIG. 7 illustrates an example process flow 700 that can facilitate moving file sequences together across multiple folders, in accordance with certain embodiments of this disclosure. In some examples, aspects of process flow 700 can be implemented by file system transfer component 104 of FIG. 1. It can be appreciated that the operating procedures of process flow 700 are example operating procedures, and that there can be embodiments that implement more or fewer operating procedures than are depicted, or that implement the depicted operating procedures in a different order than as depicted.

Process flow 700 begins with 702, and moves to operation 704. Operation 704 depicts receiving a first user input via a user interface indicative of a transfer at least a first file and a second file from a source folder to a destination folder, the first file and the second file being named according to a sequencing of files. That is, there can be a source folder that contains a file sequence, which a user has provided input to copy to a destination.

In some examples, operation 704 comprises presenting both a first name of the first file and a second name of the second file with one entry in user interface. That is, the original set of sequential files in the parent folder can be presented in one entry in a user interface (such as user interface 500). If there is a sequence of files made up of LA_IMG100.JPG and LA_IMG101.JPG, this can be presented as LA_IMG[100-101].JPG in the user interface. After operation 704, process flow 700 moves to operation 706.

In some examples, operation 704 comprises identifying the sequencing of files based on a first name of the first file and a second name of the second file. That is, the sequencing of files (sometimes referred to as a sequencing process) can be determined from the names of the files themselves, as opposed to a sequencing of files that is predetermined before the files are analyzed. In other examples, the sequencing of files can be predetermined.

Operation 706 depicts, in response to the receiving the first user input, identifying a subfolder of the source folder. That is, there can be a subfolder in the source folder, and it can be examined for more files that are named according to the naming convention of the file sequence of operation 704.

In some examples, operation 706 comprises identifying the subfolder of the source folder comprises enumerating a group of subfolders of the source folder that comprises the subfolder. That is, all subfolders of the source folder can be enumerated, and examined for files that are named in accordance with the file sequence.

In some examples, operation 706 comprises identifying the subfolder of the source folder in response to receiving user input via the user interface indicative of checking subfolders. That is, a user interface dialog can be presented to a user asking whether the user desires for subfolders to be checked for more files that are named in accordance with the file sequence.

In some examples, operation 706 (and 710) can comprise, in response to the determining that there is a fourth file located in a second subfolder of the first subfolder that is named according to the sequencing protocol, further transferring the fourth file to the destination folder. That is, subfolders of subfolders, etc., can be examined After operation 706, process flow 700 moves to operation 708.

Operation 708 depicts determining that there is a third file located in the subfolder that is named according to the sequencing of files. That is, within a subfolder, another file that is named according to the naming convention of the file sequence of operation 704 can be identified.

In some examples, operation 708 comprises determining that there is a fourth file located in a first parent folder that is named according to the sequencing process. That is, in some examples, parent folders of the source folder can be examined for more files that are named according to a file sequence. Examining parent folders can be done in addition to, or instead of, examining subfolders. In such examples, operation 710 can then comprise, in response to the determining that there is the fourth file located in the first parent folder that is named according to the sequencing process, the transferring further comprises transferring the fourth file to the destination folder. That is, where files are identified in parent folders that are named according to the naming scheme, they can also be transferred in operation 710 along with the originally selected files. After operation 706, process flow 700 moves to operation 708.

Operation 710 depicts in response to the determining that there is a third file located in the subfolder that is named according to the sequencing of files, transferring the first file, the second file, and the third file to the destination folder. That is, all three files of the file sequence can be copied to the destination.

In some examples, operation 710 comprises presenting an indication that the third file is named according to the sequencing of files via the user interface, and receiving user input indicative of a selection of the third file for the transferring to the destination folder. That is, in some examples, a user can select whether to include additional files (like the third file) that are located in subfolders in the transfer.

In some examples, operation 710 comprises presenting an indication that the third file is named according to the sequencing of files via the user interface, and receiving user input indicative of a selection of the third file for the transferring to the destination folder. That is, in some examples, a user can select whether to include additional files (like the third file) that are located in subfolders in the transfer.

In some examples, operation 710 comprises presenting an indication that the third file is named according to the sequencing of files via the user interface, and that there is a fourth file located in the subfolder that is named according to the sequencing of files via the user interface; and receiving user input indicative of a first selection of the third file for the transferring to the destination folder without receiving user input indicative of a second selection of the fourth file for the transferring to the destination folder. That is, there can be examples where some of these additional files are selected for transfer.

In some examples, operation 710 comprises presenting an indication that the third file is named according to the sequencing of files via the user interface, and that there is a fourth file located in the subfolder that is named according to the sequencing of files in the user interface; and receiving user input indicative of a selection of the third file and the fourth file for the transferring to the destination folder, wherein the transferring the first file, the second file, and the third file to the destination folder comprises transferring the fourth file to the destination folder. That is, there can be examples where all of these additional files are selected for transfer.

In some examples, operation 710 comprises presenting a user interface that accepts user input indicative of transferring a defined number of files identified in subfolders of the source folder. That is, in some examples, a user can select whether Some, All, or None of the relevant files found in subfolders should be transferred, e.g., by providing user input at one of Some check box 506a, All check box 506b, and None check box 506c.

In some examples, the first file, the second file and the third file comprise respective computer files stored in a computer file system structure that comprises the source folder and the first subfolder. That is, these files are part of a computer file system.

In some examples, operation 710 comprises maintaining the folder hierarchy in the destination folder when performing the transferring. That is, in some examples, a folder hierarchy can be maintained when transferring files located in subfolders. So, if file LA_IMG100.JPG is stored in FOLDER A, and file LA_IMG101.JPG is stored in FOLDER B (which is a subfolder of FOLDER A), then this folder hierarchy can be maintained when transferred. That is, LA_IMG100.JPG and FOLDER B can be transferred to the destination folder, and LA_IMG101.JPG can be stored in FOLDER B on the destination folder. This arrangement of FOLDER A relative to FOLDER B can be referred to as a folder hierarchy.

In other examples, operation 710 can comprise transferring the first file, the second file, and the third file to a same folder of the destination folder. That is, there can be examples where all transferred files can be transferred to the same folder. After operation 710, process flow 700 moves to 712, where process flow 700 ends.

FIG. 8 illustrates an example process flow 800 that can facilitate moving file sequences together across multiple folders, in accordance with certain embodiments of this disclosure. In some examples, aspects of process flow 800 can be implemented by file system transfer component 104 of FIG. 1. It can be appreciated that the operating procedures of process flow 800 are example operating procedures, and that there can be embodiments that implement more or fewer operating procedures than are depicted, or that implement the depicted operating procedures in a different order than as depicted.

Process flow 800 begins with 802, and moves to operation 804. Operation 804 depicts receiving a user input at a user interface indicative of transferring at least a first file and a second file from a source folder to a destination folder, the first file and the second file being named according to a sequencing process employed by the system. In some examples, operation 804 can be implemented in a similar manner as operation 704 of FIG. 7. After operation 804, process flow 800 moves to operation 806.

Operation 806 depicts determining that there is a third file located in a subfolder of the source folder that is named according to the sequencing process. In some examples, operation 806 can be implemented in a similar manner as operations 706 and 708 of FIG. 7. After operation 806, process flow 800 moves to operation 808.

Operation 808 depicts, in response to the determining that there is a third file located in the subfolder that is named according to the sequencing process, performing the transferring of the first file, the second file, and the third file to the destination folder. In some examples, operation 808 can be implemented in a similar manner as operation 710 of FIG. 7. After operation 808, process flow 800 moves to 810, where process flow 800 ends.

FIG. 9 illustrates an example process flow 900 that can facilitate moving file sequences together across multiple folders, in accordance with certain embodiments of this disclosure. In some examples, aspects of process flow 900 can be implemented by file system transfer component 104 of FIG. 1. It can be appreciated that the operating procedures of process flow 900 are example operating procedures, and that there can be embodiments that implement more or fewer operating procedures than are depicted, or that implement the depicted operating procedures in a different order than as depicted.

Process flow 900 beings with 902, and moves to operation 904. Operation 904 depicts determining to transfer a first file and a second file from a source folder to a destination folder, the first file and the second file being named according to a sequencing protocol. In some examples, operation 904 can be implemented in a similar manner as operation 704 of FIG. 7. After operation 904, process flow 900 moves to operation 906.

Operation 906 depicts determining that there is a third file located in a first subfolder of the source folder that is named according to the sequencing protocol. In some examples, operation 906 can be implemented in a similar manner as operations 706 and 708 of FIG. 7.

After operation 906, process flow 900 moves to operation 908. Operation 908 depicts, in response to the determining that there is the third file located in the first subfolder that is named according to the sequencing protocol, transferring the first file, the second file, and the third file to the destination folder. In some examples, operation 908 can be implemented in a similar manner as operation 710 of FIG. 7. After operation 908, process flow 900 moves to 910, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented. For example, aspects of computing environment 1000 can be used to implement aspects of source computer 102a and/or destination computer 102b of FIG. 1. In some examples, computing environment can implement aspects of the process flows of FIGS. 6-9 to facilitate identifying and deleting idle remote sessions in a distributed file system.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the first processor, facilitate performance of operations, comprising:
receiving a first user input via a user interface indicative of a transfer at least a first file and a second file from a source folder to a destination folder, the first file and the second file being named according to a sequencing of files;
in response to the receiving the first user input, identifying a subfolder of the source folder;
determining that there is a third file located in the subfolder that is named according to the sequencing of files; and
in response to the determining that there is a third file located in the subfolder that is named according to the sequencing of files, transferring the first file, the second file, and the third file to the destination folder.

2. The system of claim 1, wherein the operations further comprise:
presenting an indication that the third file is named according to the sequencing of files via the user interface; and
receiving user input indicative of a selection of the third file for the transferring to the destination folder.

3. The system of claim 1, wherein the operations further comprise:
presenting an indication that the third file is named according to the sequencing of files via the user interface, and that there is a fourth file located in the subfolder that is named according to the sequencing of files via the user interface; and
receiving user input indicative of a first selection of the third file for the transferring to the destination folder without receiving user input indicative of a second selection of the fourth file for the transferring to the destination folder.

4. The system of claim 1, wherein the operations further comprise:
presenting an indication that the third file is named according to the sequencing of files via the user interface, and that there is a fourth file located in the subfolder that is named according to the sequencing of files in the user interface; and
receiving user input indicative of a selection of the third file and the fourth file for the transferring to the destination folder,
wherein the transferring the first file, the second file, and the third file to the destination folder comprises transferring the fourth file to the destination folder.

5. The system of claim 1, wherein the operations further comprise:
presenting both a first name of the first file and a second name of the second file with one entry in user interface.

6. The system of claim 1, wherein the identifying the subfolder of the source folder is performed in response to receiving user input via the user interface indicative of checking subfolders.

7. The system of claim 1, wherein the identifying the subfolder of the source folder comprises enumerating a group of subfolders of the source folder that comprises the subfolder.

8. A method, comprising:
receiving, by a system comprising a processor, a user input at a user interface indicative of transferring at least a first file and a second file from a source folder to a destination folder, the first file and the second file being named according to a sequencing process employed by the system;
determining, by the system, that there is a third file located in a subfolder of the source folder that is named according to the sequencing process; and
in response to the determining that there is a third file located in the subfolder that is named according to the sequencing process, performing, by the system, the transferring of the first file, the second file, and the third file to the destination folder.

9. The method of claim 8, further comprising:
identifying, by the system, the sequencing process based on a first name of the first file and a second name of the second file.

10. The method of claim 8, further comprising:
determining, by the system, that there is a fourth file located in a first parent folder that is named according to the sequencing process.

11. The method of claim 10, further comprising:
in response to the determining that there is the fourth file located in the first parent folder that is named according to the sequencing process, the transferring further comprises transferring the fourth file to the destination folder.

12. The method of claim 8, further comprising:
enumerating, by the system, a group of subfolders of the source folder that comprises the subfolder.

13. The method of claim 12, wherein the user input is first user input, and further comprising:
performing, by the system, the enumerating in response to receiving user input at a second user interface indicative of checking for the group of subfolders of the source folder.

14. The method of claim 8, further comprising:
identifying, by the system, at least one file named according to the sequencing process and that comprises the third file in the group of subfolders; and
in response to the determining that there is the third file in the subfolder that is named according to the sequencing process, performing the transferring of the first file, the second file, and the third file to the destination folder.

15. A computer-readable storage medium comprising instructions that, in response to execution, cause a system comprising a processor to perform operations, comprising:
determining to transfer a first file and a second file from a source folder to a destination folder, the first file and the second file being named according to a sequencing protocol;
determining that there is a third file located in a first subfolder of the source folder that is named according to the sequencing protocol; and
in response to the determining that there is the third file located in the first subfolder that is named according to the sequencing protocol, transferring the first file, the second file, and the third file to the destination folder.

16. The computer-readable storage medium of claim 15, wherein the operations further comprise:
in response to the determining that there is a fourth file located in a second subfolder of the first subfolder that is named according to the sequencing protocol, further transferring the fourth file to the destination folder.

17. The computer-readable storage medium of claim 15, wherein the first file, the second file and the third file comprise respective computer files stored in a computer file system structure that comprises the source folder and the first subfolder.

18. The computer-readable storage medium of claim 15, wherein the operations further comprise:
presenting a user interface that accepts user input indicative of transferring a defined number of files identified in subfolders of the source folder.

19. The computer-readable storage medium of claim 15, wherein the source folder and the first subfolder comprise a folder hierarchy, and wherein the operations further comprise:
maintaining the folder hierarchy in the destination folder when performing the transferring.

20. The computer-readable storage medium of claim 15, wherein the source folder and the first subfolder comprise a folder hierarchy, and wherein the transferring further comprises:
transferring the first file, the second file, and the third file to a same folder of the destination folder.
